(19) United States
(12) Patent Application Publication
(10) Pub. No.: US 2015/0312993 A1
(43) Pub. Date: Oct. 29, 2015

(54) ILLUMINANT DEVICE AND CONTROLLING MODULE THEREOF

(71) Applicant: Hergy Lighting Technology Corp., Taipei City (TW)

(72) Inventors: Cheng-Jen LEE, Taipei City (TW); Chun-Hung LU, Taipei City (TW); Chien-Hong CHEN, Taipei City (TW)

(73) Assignee: Hergy Lighting Technology Corp., Taipei City (TW)

(21) Appl. No.: 14/260,853

(22) Filed: Apr. 24, 2014

(51) Int. Cl. H05B 37/02

(52) U.S. Cl. CPC H05B 37/0272

(57) ABSTRACT

A controlling module controls illuminant state of an illuminant module according to a controlling signal sent form a wireless controller. The controlling module is electrically connected to the illuminant module and includes a microprocessor, a wireless receiver, a regulator, and a driving unit. The wireless receiver is electrically connected to the microprocessor and receives the controlling signal sent form the wireless controller. The regulator is electrically connected to the microprocessor. The driving unit is electrically connected to the microprocessor and the illuminant module.

### BACKGROUND OF THE INVENTION

1. Field of the Invention

The present invention relates to an illuminant device, and in particular to an illuminant device having wireless dimming function.

2. Description of Related Art

A light emitting diode (LED) is a kind of semiconductor device, which exploits the property of direct-bandgap semiconductor material to convert electric energy into light energy efficiently and has advantages of long lifetime, high stability and low power consumption and is developed to replace the traditional non-directivity light tube and incandescent lamp.

In general, the controlling functions for an illuminant device having LEDs is inconvenient because used have to touch a switch disposed on the illuminant device, or a switch fixed on the wall, or a controller connected to the illuminant device via a transmitting wire.

### SUMMARY OF THE INVENTION

The object of the present invention is to provide a controlling module, capable of controlling illuminant states of an illuminant module by a controlling signal sent form a wireless controller.

Accordingly, the controlling module is electrically connected to the illuminant module. The controlling module comprises a microprocessor, a wireless receiver, a regulator, and the driving unit. The wireless receiver is electrically connected to the microprocessor and receives the controlling signal sent form the wireless controller, the regulator is electrically connected to the microprocessor, the driving unit is electrically connected to the microprocessor and the illuminant module.

In an embodiment of the present invention, the regulator is a DC to DC power convertor.

The present provides an illuminant device for receiving a controlling signal sent from a wireless controller and modulating illuminant state thereof. The illuminant device comprises power supplying unit, a controller, and an illuminant module. The controlling module comprises a microprocessor, a wireless receiver, a regulator, and a driving unit. The wireless receiver is electrically connected to the microprocessor and receiving the controlling signal sent from the wireless controller. The regulator is electrically connected to the microprocessor and the power supplying unit. The driving unit is electrically connected to the microprocessor and the power supplying unit. The illuminant module is electrically connected to the driving unit.

In an embodiment of the present invention, the illuminant device further comprises a power supplying unit electrically connected to the regulator and the driving unit.

In an embodiment of the present invention, the power supplying unit is a DC power supplier.

In an embodiment of the present invention, the regulator comprises a DC to DC converter.

In an embodiment of the present invention, the driving unit is a boost converter.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit diagram of an illuminant device of the present invention.

### DETAILED DESCRIPTION OF THE INVENTION

A preferred embodiment of the present invention will be described with reference to the drawings.

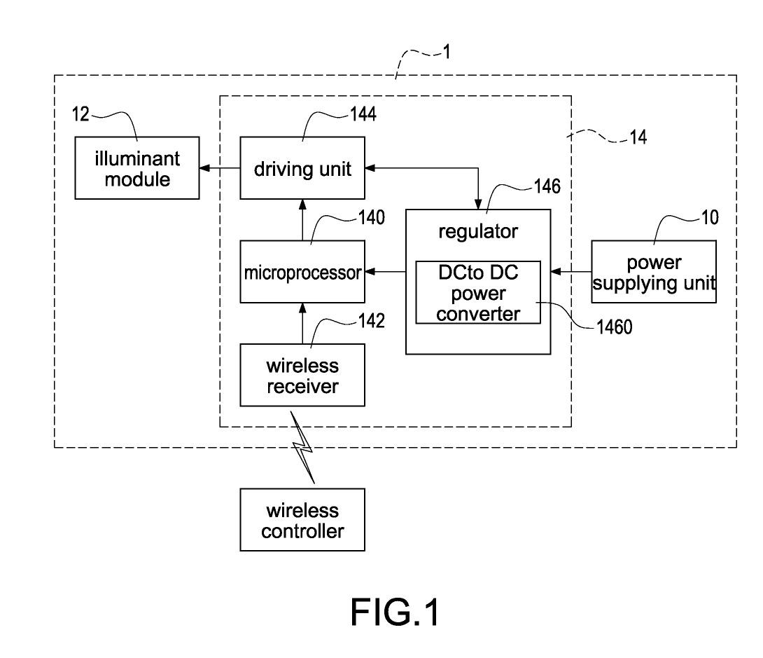

Reference is made to FIG. 1, which is a circuit diagram of the present invention. The illuminant device 1 receives a controlling signal sent from a wireless controller 2 and then illuminant states (such as light or shade) of the illuminant device 1 can be modulated according to the controlling signal. The illuminant device 1 is, for example, light bulb, lamp panel, or light string. The wireless controller 2 is, for example, server, personal computer (PC), tablet computer, or mobile phone having Bluetooth transmitter, infrared transmitter, or Radio-frequency identification (RFID) transmitter.

The illuminant device 1 includes a power supplying unit 10, a illuminant module 12, and a controlling module 1. The power supplying unit 10 is electrically connected to the controlling module 14 and used for providing electric power to the illuminant device 1 in operation. The power supplying unit 10 can be direct current (DC) power supplier (such as battery) or alternative current (AC) supplier.

The illuminant module 12 is electrically connected to the controlling module 14. The illuminant module 12 is composed of a plurality of light emitting diodes (LEDs), the arrangement of the LEDs are adjusted by format of the illuminant device 1. For example, the LEDs can be arranged in string or lamp panel form.

The controlling module 14 is electrically connected to the power supplying unit 10 and the illuminant module 12. The controlling module 14 receives the controlling signal sent form the wireless controller 2 and controls illuminant state of the illuminant module 12.

The controlling module 14 includes a microprocessor 140, a wireless receiver 142, a driving unit 144, and a regulator 146. The microprocessor 140 is electrically connected to the wireless receiver 142, the regulator 146, and the driving unit 144. The regulator 146 is electrically connected to the power supplying unit 10, and the driving unit 144 is electrically connected to the power supplying unit 10 and the illuminant module 12.

The wireless receiver 142 receives the controlling signal sent form the wireless controller 2 and transmits the controlling signal to the microprocessor 140. The transmitting interface of the wireless receiver 142 corresponds to the interface of the wireless controller 2, and can be Bluetooth receiver, infrared receiver, or RFID receiver.

The regulator 146 includes a DC to DC power converter 1460. The DC to DC power converter 1460 can regulate voltage level of the DC electric power provided by the power supplying unit 10 when the power supplying unit 10 is a DC power supplier. In this embodiment, the DC to DC power converter 1460 is used to reduce voltage level of the electric power outputted form power supplying unit 10.

The driving unit 144 receives a driving signal sent form the microprocessor and then adjusts illuminant states of the illuminant module 12. In this embodiment, the microprocessor 140 provides a pulse width modulating signal to the driving unit 144, thus the driving unit 144 can adjust illuminant states of the illuminant module 12. In additions, the driving unit 144 mentioned in this embodiment is a boost converter.

In the practical applications, the wireless receiver 142 receives the controlling signal sent form the wireless controller, and then transmits the controlling signal to the microprocessor 140. The microprocessor 140 receives the controlling signal and sends a driving signal to the driving unit 144 according to the controlling signal. The driving unit 144 controls the illuminant module according to the driving signal.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A controlling module electrically connected to an illuminant module, the controlling module receiving a controlling signal and then controlling illuminant states of the illuminant module according to the controlling signal sent from a wireless controller, the controlling module comprising:
a microprocessor;
a wireless receiver electrically connected to the microprocessor and wireless receiving the controlling signal sent form the wireless controller;
a regulator electrically connected o the processor; and
a driving unit electrically connected to the microprocessor and the illuminant module.

2. The controlling module in claim 1, wherein the regulator comprises a direct current (DC) to DC power converter.

3. An illuminant device used for receiving a controlling signal sent form the wireless controller, the illuminant device comprising:
a power supplying unit;
a controlling module comprising:
a microprocessor;
a wireless receiver electrically connected to the microprocessor and receiving the controlling signal sent form the wireless controller;
a regulator electrically connected to the microprocessor and the power supplying unit; and
a driving unit electrically connected to the microprocessor and the power supplying unit; and
an illuminant module electrically connected to the driving unit.

4. The illuminant device in claim 3, further comprising a power supplying unit electrically connected to the regulator and the driving unit.

5. The illuminant device in claim 4, wherein the power supplying unit is a DC power supplier.

6. The illuminant device in claim 5, wherein the regulator is a DC to DC power convertor.

7. The illuminant device in claim 3, wherein the driving unit is a boost converter.
